(19) United States
(12) Patent Application Publication
(10) Pub. No.: US 2006/0139582 A1
(43) Pub. Date: Jun. 29, 2006

(54) PROJECTION DISPLAY APPARATUS AND FOCUS ADJUSTMENT METHOD FOR THE SAME

(75) Inventor: Kimiaki Saito, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/231,781

(22) Filed: Sep. 22, 2005

(30) Foreign Application Priority Data
Dec. 27, 2004 (JP) 2004378186

(51) Int. Cl. G03B 21/14

(52) U.S. Cl. 353/101

(57) ABSTRACT

In a projection display apparatus of this invention, a projection lens projects an image onto a screen. A video signal output circuit outputs a distance measurement image to the lens. A line sensor receives, by a plurality of light-receiving elements aligned along a direction crossing the projection optical axis of the lens, distance measurement image light which is projected on the screen by the lens and reflected by the screen, and outputs a signal corresponding to a position at which the distance measurement image light is received. A control unit calculates a distance between the lens and the screen by a trigonometric distance measurement on the basis of the signal output from the line sensor, and outputs a control signal based on the calculated distance. A motor driving circuit adjusts the focus of the lens on the basis of the control signal output by the control unit.

### CROSS-REFERENCE TO RELATED APPLICATIONS

This application is based upon and claims the benefit of priority from prior Japanese Patent Application No. 2004-378186, filed Dec. 27, 2004, the entire contents of which are incorporated herein by reference.

### BACKGROUND OF THE INVENTION

1. Field of the Invention

The present invention relates to a projection display apparatus which enlarges and projects an image displayed on a display device onto a screen, and a focus adjustment method for the same.

2. Description of the Related Art

For example, in Jpn. Pat. Appln. KOKAI Publication Nos. 05-188282 and 2004-125770, a focus distance adjustment mechanism using a passive sensor in which a pair of line sensors are modularlized is available as a mechanism for adjusting the focus distance of a projection unit in a projection display apparatus which has a transmission or reflection type display device and enlarges and projects an image displayed on the display device onto a screen.

However, the focus distance adjustment mechanism using the passive sensor must have two pairs of line sensors and optical systems for forming an image on the line sensors. Hence, the apparatus becomes complex, large in size, and expensive.

### BRIEF SUMMARY OF THE INVENTION

According to an embodiment of the present invention, a projection display apparatus comprises a projection unit configured to project an image onto a screen, an image output unit configured to output a distance measurement image to the projection unit, a light-receiving unit configured to receive, by a plurality of light-receiving elements aligned along a direction crossing a projection optical axis of the projection unit, distance measurement image light which is projected on the screen by the projection unit and reflected by the screen, and output a signal corresponding to a position at which the distance measurement image light is received, a distance calculation unit configured to calculate a distance between the projection unit and the screen by a trigonometric distance measurement on the basis of the output signal from the light-receiving unit, and output a control signal based on the calculated distance, and a focus adjustment unit configured to adjust a focus of the projection unit on the basis of the control signal output by the distance calculation unit.

According to another embodiment of the present invention, a focus adjustment method of a projection display apparatus including a projection unit which enlarges and projects an image displayed on a display device onto a screen, comprises projecting a distance measurement image from the projection unit to the screen, receiving distance measurement image light reflected by the screen using a plurality of light-receiving elements aligned along a direction crossing a projection optical axis of the projection unit, calculating a distance between a projection base point of the projection unit and a point at which the projection optical axis and a screen surface cross on the screen, by a trigonometric distance measurement on the basis of a signal corresponding to a position at which the distance measurement image light is received by the light-receiving element, and adjusting a focus of the projection unit in accordance with a control signal based on the calculated distance.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an arrangement of a projection display apparatus according to an embodiment of the present invention;

FIG. 2 is a view for explaining the distance measurement principle of a distance measurement mechanism according to the embodiment of the present invention;

FIG. 3 is a front view from the screen side of a housing which houses a projection lens and a line sensor;

FIG. 4 is a view showing an example of a distance measurement image according to the embodiment of the present invention;

FIG. 5 is a conceptual view for explaining an example of a setting process of the positions of the projection display apparatus and the screen according to the embodiment of the present invention;

FIG. 6A is a view showing an example of horizontal bars displayed on the screen before adjusting the positions of the projection display apparatus and the screen according to the embodiment of the present invention;

FIG. 6B is a view showing an example of horizontal bars displayed on the screen after adjusting the positions of the projection display apparatus and the screen according to the embodiment of the present invention; and

FIG. 7 is a flowchart showing an example of the processing sequence of the projection display apparatus according to the embodiment of the present invention.

### DETAILED DESCRIPTION OF THE INVENTION

An embodiment of the present invention will be described below with reference to the accompanying drawing.

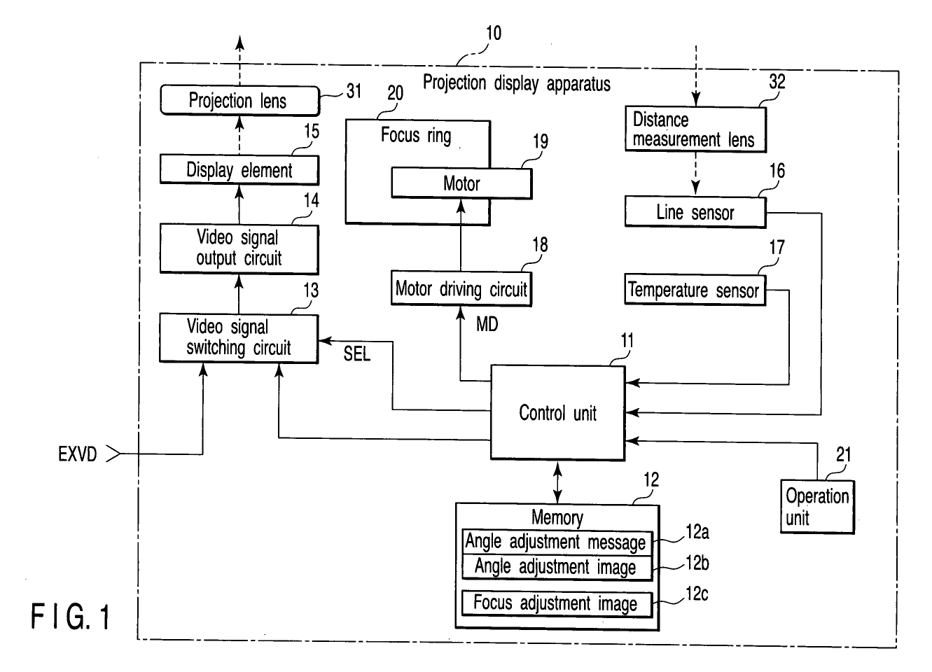

FIG. 1 shows an arrangement of a projection display apparatus according to the embodiment of the present invention.

According to the embodiment of the present invention, a projection display apparatus 10 includes elements such as a control unit 11, memory 12, video signal switching circuit 13, video signal output circuit 14, display element 15, line sensor 16, temperature sensor 17, motor driving circuit 18, motor 19, focus ring 20, operation unit 21, projection lens 31, and distance measurement lens 32.

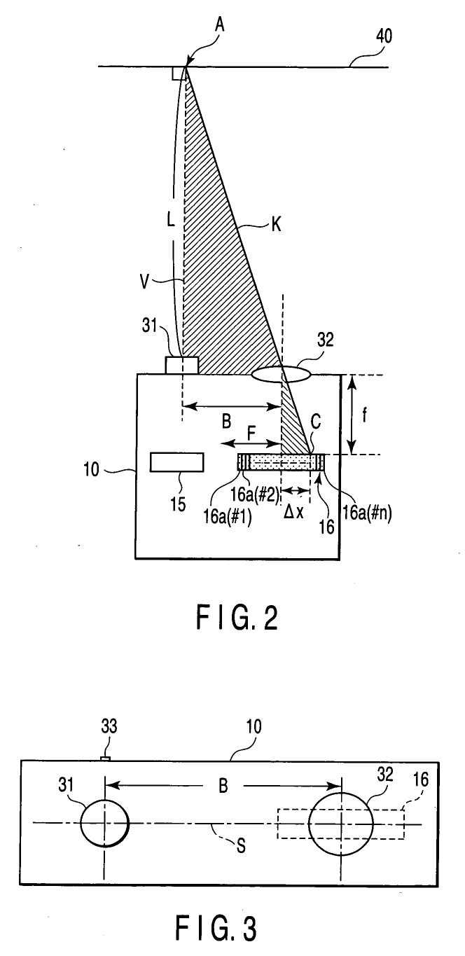

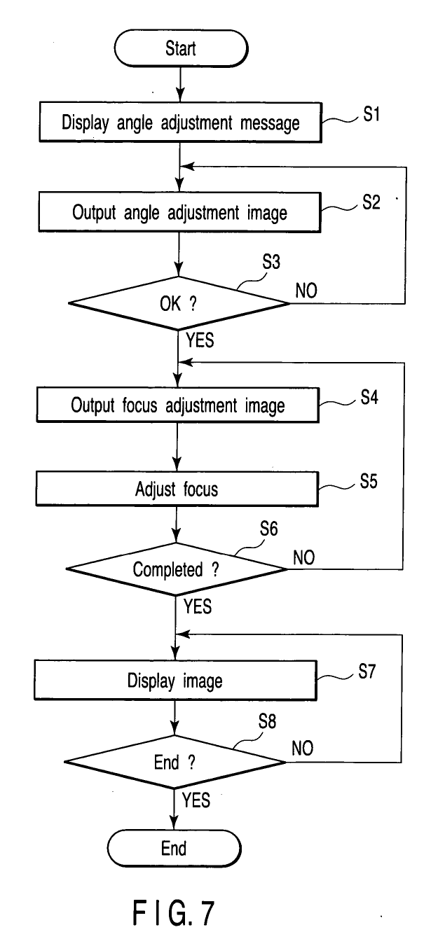

The control unit 11 controls the operations of the overall projection display apparatus 10. Although not limited to the following, the control unit 11 is implemented using, e.g., a microprocessor. According to a program stored in the memory 12, the focus adjustment of the projection lens 31 is performed in accordance with an output signal from one line sensor 16 in the processing sequence shown in FIG. 7 by a trigonometric distance measurement principle shown in FIG. 2.

The memory 12 stores the program performed by the control unit 11 and various data including display image data. In this case, in addition to the program including a focus adjustment routine in the processing sequence shown in FIG. 7 and the display image data, the memory 12 stores angle adjustment message data 12a, angle adjustment image data 12b, focus adjustment image data 12c, and the like.

The video signal switching circuit 13 selects an image to be projected onto the screen, under the control of the control unit 11. In accordance with a switching control signal SEL output from the control unit 11, the video signal switching circuit 13 switches between a video signal generated in the apparatus 10 and an externally supplied video signal EXVD, and outputs the selected video signal.

The video signal output circuit 14 generates image data for display drive on the basis of the video signal from the video signal switching circuit 13. The generated image data is sent to the display element 15.

The display element 15 includes a projection unit in addition to the projection lens 31. The display element 15 is a transmission or reflection type display device which displays and outputs the image data from the video signal output circuit 14.

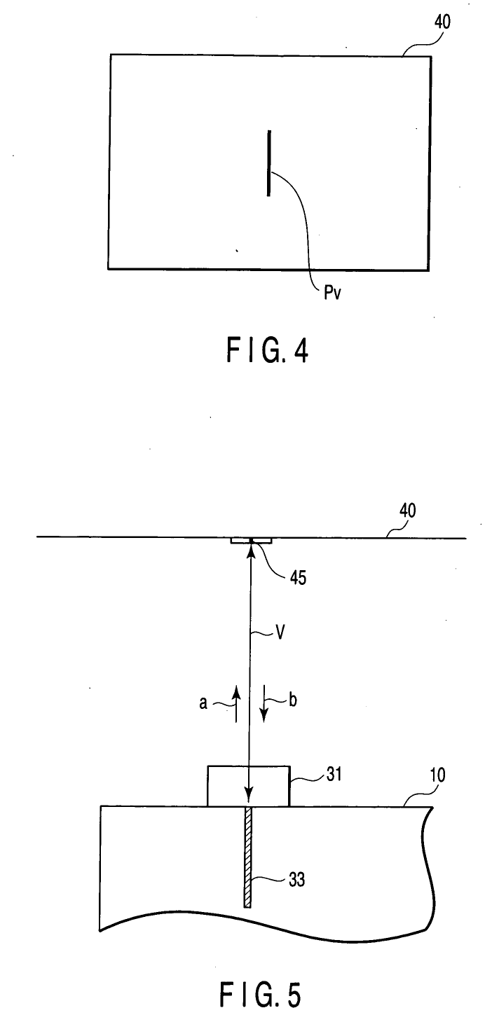

The line sensor 16 includes a distance measurement light-receiving unit in addition to the distance measurement lens 32. As shown in FIGS. 2 and 3, at the focal position of the distance measurement lens 32, a plurality of light-receiving elements 16a (#1, #2, . . . , #n) are aligned along a direction F crossing a projection optical axis K of the line sensor 16. When a distance measurement image Pv is projected from the projection lens 31 onto the screen 40 as shown in FIG. 4, the line sensor 16 receives distance measurement image light reflected by the screen 40, using one of the plurality of light-receiving elements 16a (#1, #2, . . . , #n) aligned along the direction F crossing the projection optical axis K of the distance measurement lens 32. The line sensor 16 then outputs a signal corresponding to an arrangement position of the light-receiving element which has received the light. On the basis of the output signal from the line sensor 16, a focus distance f of the distance measurement lens 32, and a baseline length B corresponding to the distance between the optical axes of the projection lens 31 and distance measurement lens 32, the control unit 11 calculates a distance L between the projection base point of the projection lens 31 and a point A at which the projection optical axis and the screen surface cross on the screen 40, by the trigonometric distance measurement shown in FIG. 2. On the basis of the calculated distance L, a motor driving signal MD is generated. The motor 19 is then driven to control the rotational position of the focus ring 20 and adjust the focus of the projection lens 31.

The temperature sensor 17 monitors the temperature of the line sensor 16 having temperature characteristics, and sends a temperature sensing signal to the control unit 11. The control unit 11 corrects a position signal output from the line sensor 16 on the basis of the temperature sensing signal received from the temperature sensor 17.

The motor driving circuit 18 controls to drive the motor 19 in accordance with the motor driving signal MD output from the control unit 11, to rotate the focus ring 20. The motor driving circuit 18 then controls the rotational position of the focus ring 20 to adjust the focus of the projection lens 31. On the basis of distance measurement data obtained by distance measurement calculation (to be described later), the control unit 11 obtains a table in which a prepared focus distance and a motor speed are made to correspond to each other to calculate the motor speed. The control unit 11 also generates the motor driving signal MD according to the motor speed, and sends the motor driving signal MD to the motor driving circuit 18.

The operation unit 21 includes an operation button which is operated by a user. In accordance with the operation of the operation button, various instruction signals are sent to the control unit 11. Although not limited to the following, the various instruction signals include the start and end signals of the focus adjustment on the basis of the operation of the operation button.

As shown in FIGS. 2 and 3, the projection lens 31 and distance measurement lens 32 are separated from each other through a predetermined gap on the front surface of the housing in the projection display apparatus 10. On the upper surface of the housing, as shown in FIGS. 3 and 5, a linear adjustment mark 33 parallel to an optical axis V is so formed as to overlap with the optical axis V of the projection lens 31. The adjustment mark 33 is used as described later with reference to FIG. 5.

FIG. 2 shows the distance measurement principle of the distance measurement mechanism using one line sensor 16 according to the embodiment of the present invention. As shown in FIG. 3, the distance measurement lens 32, line sensor 16, and projection lens 31 are so arranged as to set their center heights at the same reference height S. Hence, their relative positions are determined. The above-described distance measurement principle is obtained by the trigonometric distance measurement. Since two hatched triangles are geometrically similar, the length and distances have the following relationship:
L:B=f:Δx
→L=Bf/Δx (1)
where L represents a distance between the projection base point of the projection lens 31 and the point A at which the projection optical axis V and the screen surface cross on the screen 40, B; a baseline length corresponding to a distance between the optical axes of the projection lens 31 and distance measurement lens 32, f; a focus distance of the distance measurement lens 32, C; an imaging point on the line sensor 16, and Δx; a distance between the center of the line sensor 16 and the light-receiving element which has received the distance measurement image light reflected by the screen 40. The distance Δx can be obtained from an output signal from the light-receiving element which has received the light. Based on equation (1), the distance L can be obtained by the baseline length B, focus distance f, and value Δx. The distance measurement mechanism including only one line sensor 16 is implemented using this distance measurement principle.

In order to accurately perform the distance measurement in the distance measurement mechanism, two triangles of a hatched portion in FIG. 2 must be two-dimensionally arranged. Hence, in this embodiment, as shown in FIG. 3, the distance measurement lens 32, line sensor 16, and projection lens 31 are so arranged as to set their center heights at the same reference height S.

The distance measurement is performed by the distance measurement mechanism using the distance measurement image Pv. FIG. 4 shows an example of the distance measurement image Pv. Note that the vertical linear distance measurement image Pv is projected at the center of the screen surface of the screen 40. One of the light-receiving elements in the line sensor 16 receives the distance measurement image light reflected by the screen surface, via the distance measurement lens 32. Hence, the control unit 11 calculates the distance L shown in FIG. 2, and the focus of the projection lens 31 is adjusted on the basis of the calculated value.

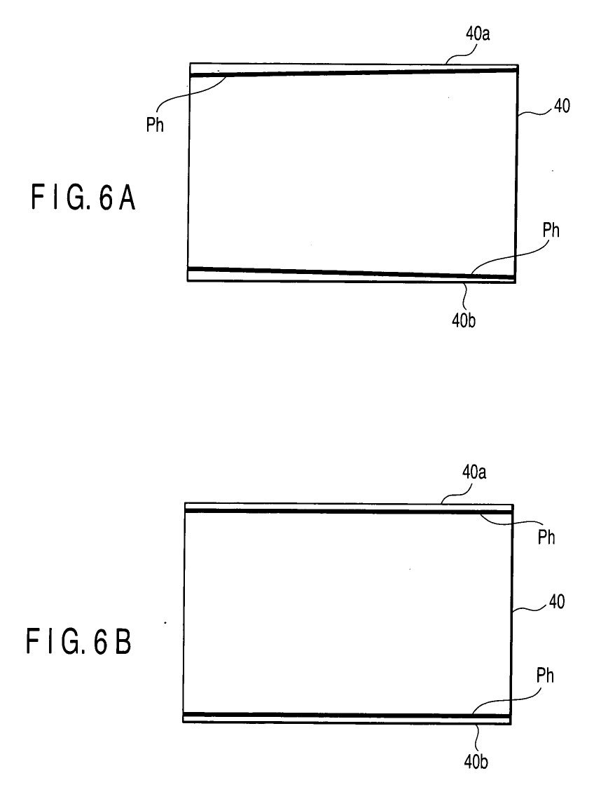

In this distance measurement mechanism, as shown in FIG. 2, the relative positions of the projection display apparatus 10 and screen 40 are set such that the optical axis direction V of the projection lens 31 is set perpendicular to the screen surface of the screen 40. FIGS. 5 and 6 show these setting examples.

In the setting example shown in FIG. 5, a mirror 45 parallel to the screen surface is arranged at the center of the screen surface of the screen 40. A vertical linear adjustment image (exit light a) is projected from the projection lens 31 of the projection display apparatus 10 onto the screen surface of the screen 40. In contrast to this, vertical linear light (reflected light b) reflected by the mirror 45 is visually recognized at a position wherein the projection lens 31 of the projection display apparatus 10 is arranged. In the example shown in FIG. 5, on the upper surface of the housing of the projection display apparatus 10, the linear adjustment mark 33 parallel to the optical axis V is so formed as to overlap with the optical axis V of the projection lens 31. The vertical linear light reflected by the mirror 45 is visually observed on the upper side of the linear adjustment mark 33. In order to overlap both center axes, i.e., in order to overlap the exit light a from the projection lens 31 and the reflected light b, the angle between the screen surface of the screen 40 and the projection display apparatus 10 is adjusted. Note that instead of the linear adjustment mark 33, a viewing window may be arranged at the position to observe the reflected light b from the viewing window (or sense the reflected light b by an optical sensor).

In the setting example shown in FIGS. 6A and 6B, the adjustment image having horizontal bars Ph corresponding to upper and lower edge lines 40a and 40b of the screen surface is projected from the projection lens 31 of the projection display apparatus 10 onto the screen surface of the screen 40. Then, the angle between the screen surface of the screen 40 and the projection display apparatus 10 is so adjusted as to set the horizontal bars Ph parallel to the upper and lower edge lines of the screen surface. FIG. 6A shows an example of an unadjusted state wherein the horizontal bars Ph are not parallel to the upper and lower edge lines 40a and 40b on the screen surface. FIG. 6B shows an example of an adjusted state wherein the horizontal bars Ph are parallel to the upper and lower edge lines 40a and 40b on the screen surface.

Next, the processing sequence of the projection display apparatus 10 in the above embodiment will be described with reference to the flowchart shown in FIG. 7.

When the projection display apparatus 10 receives an operation power supply voltage, the control unit 11 adjusts the focus of the projection lens 31 on the basis of the program stored in the memory 12, in accordance with the output signal from one of the light-receiving elements in one line sensor 16 by the trigonometric distance measurement principle shown in FIG. 2.

When the power supply is turned on (power ON), the control unit 11 reads out the angle adjustment message data 12a from the memory 12, and projects an angle adjustment message based on the angle adjustment message data 12a onto the screen surface of the screen 40 (step S1).

The control unit 11 then reads out the angle adjustment image data 12b from the memory 12, and projects the angle adjustment image based on the angle adjustment image data 12b onto the screen surface of the screen 40 (step S2).

In accordance with the angle adjustment message and angle adjustment image, in the adjustment method described with reference to FIGS. 5 and 6, the control unit 11 recognizes, by the operation signal from the operation unit 21, that the angle between the screen surface and the projection display apparatus 10 is adjusted (step S3: YES). Next, the control unit 11 reads out the focus adjustment image data 12c from the memory 12. On the basis of the focus adjustment image data 12c, the control unit 11 then projects the vertical linear distance measurement image Pv as shown in FIG. 4 onto the screen surface of the screen 40 (step S4).

On the other hand, in step S3, when the operation signal indicating that the angle between the screen surface and the projection display apparatus 10 is adjusted is not recognized by the operation unit 21 (step S3: NO), the flow returns to step S2.

When the vertical linear distance measurement image Pv (exit light a) is projected onto the screen 40 in step S4, the distance measurement image light (reflected light b) reflected by the screen surface enters the distance measurement lens 32. This distance measurement image light is received by the line sensor 16.

On the basis of the value Δx obtained from the output signal from the line sensor 16, the focus distance f of the distance measurement lens 32, and the baseline length B corresponding to the distance between the optical axes of the projection lens 31 and distance measurement lens 32, the control unit 11 calculates the distance L between the projection base point of the projection lens 31 and the point A at which the projection optical axis and the screen surface cross on the screen 40, by the trigonometric distance measurement based on equation (1). The control unit 11 then sends the motor driving signal MD based on the distance L to the motor driving circuit 18, controls the rotational position of the focus ring 20 by driving the motor 19, and adjusts the focus of the projection lens 31 (step S5).

When the focus adjustment is completed (step S6: YES), in accordance with the instruction operation by the operation unit 21, the control unit 11 inputs the video signal stored in the memory 12 or the externally supplied video signal EXVD to the video signal output circuit 14, and enlarges and displays the image displayed on the display element 15 on the screen surface of the screen 40, on the basis of the input video signal (step S7). After that, upon reception of an image display end instruction from the operation unit 21, the image display ends (step S8: YES), and the system power supply is shut off (power OFF).

Alternatively, in step S6, when the focus adjustment is not completed (step S6: NO), the flow returns to step S4.

In step S8, when the image display end instruction is not received from the operation unit 21 (step S8: NO), the flow returns to step S7.

According to the above embodiment, since only one pair of optical system and line sensor are arranged for the distance measurement, the overall arrangement of the projection display apparatus 10 can be simplified. Hence, the projection display apparatus having an automatic focusing function can be made smaller, light in weight, and inexpensive.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A projection display apparatus comprising:
a projection unit configured to project an image onto a screen;
an image output unit configured to output a distance measurement image to the projection unit;
a light-receiving unit configured to receive, by a plurality of light-receiving elements aligned along a direction crossing a projection optical axis of the projection unit, distance measurement image light which is projected on the screen by the projection unit and reflected by the screen, and output a signal corresponding to a position at which the distance measurement image light is received;
a distance calculation unit configured to calculate a distance between the projection unit and the screen by a trigonometric distance measurement on the basis of the signal output from the light-receiving unit, and output a control signal based on the calculated distance; and
a focus adjustment unit configured to adjust a focus of the projection unit on the basis of the control signal output by the distance calculation unit.

2. An apparatus according to claim 1, wherein the projection unit comprises
a display device which displays an image, and
a projection lens which enlarges and projects the image displayed on the display device onto the screen.

3. An apparatus according to claim 2, wherein the light-receiving unit comprises
a distance measurement lens which is juxtaposed with the projection lens, and focuses the distance measurement image light reflected by the screen, and
a line sensor which is arranged at a focal position of the distance measurement lens, and includes said plurality of light-receiving elements.

4. An apparatus according to claim 3, wherein the image output unit outputs a linear distance measurement image perpendicular to an alignment direction of said plurality of light-receiving elements.

5. An apparatus according to claim 4, wherein the distance calculation unit calculates a distance between a projection base point of the projection lens and a point at which the projection optical axis and the screen surface cross on the screen, as a distance from the projection unit to the screen, on the basis of a signal output from the line sensor, a focus distance of the distance measurement lens, and a distance between the optical axis of the projection lens and the optical axis of the distance measurement lens, by the trigonometric distance measurement.

6. An apparatus according to claim 5, wherein the image output unit comprises an adjustment image output unit which projects, from the projection unit, an adjustment image for adjusting a relative angle between the optical axis of the projection lens and the screen surface prior to the output of the distance measurement image.

7. An apparatus according to claim 6, further comprising a housing having a front surface on the screen surface side on which the projection lens and the distance measurement lens are arranged, and having an upper surface on which a linear adjustment mark parallel to the optical axis is so formed as to overlap with the optical axis of the projection lens in order to adjust the relative angle.

8. An apparatus according to claim 5, further comprising a housing having a front surface on the screen surface side on which the projection lens and the distance measurement lens are arranged, and having an upper surface on which a linear adjustment mark parallel to the optical axis is so formed as to overlap with the optical axis of the projection lens in order to adjust the relative angle between the optical axis of the projection lens and the screen surface.

9. An apparatus according to claim 4, wherein the image output unit comprises an adjustment image output unit which projects, from the projection unit, an adjustment image for adjusting a relative angle between the optical axis of the projection lens and the screen surface prior to the output of the distance measurement image.

10. An apparatus according to claim 3, wherein the distance calculation unit calculates a distance between a projection base point of the projection lens and a point at which the projection optical axis and the screen surface cross on the screen, as a distance from the projection unit to the screen, on the basis of a signal output from the line sensor, a focus distance of the distance measurement lens, and a distance between the optical axis of the projection lens and the optical axis of the distance measurement lens, by the trigonometric distance measurement.

11. An apparatus according to claim 2, wherein the image output unit outputs a linear distance measurement image perpendicular to an alignment direction of said plurality of light-receiving elements.

12. An apparatus according to claim 1, wherein the image output unit outputs a linear distance measurement image perpendicular to an alignment direction of said plurality of light-receiving elements.

13. A focus adjustment method of a projection display apparatus including a projection unit which enlarges and projects an image displayed on a display device onto a screen, comprising:
projecting a distance measurement image from the projection unit to the screen;
receiving distance measurement image light reflected by the screen using a plurality of light-receiving elements aligned along a direction crossing a projection optical axis of the projection unit;
calculating a distance between a projection base point of the projection unit and a point at which the projection optical axis and a screen surface cross on the screen, by a trigonometric distance measurement on the basis of a signal corresponding to a position at which the distance measurement image light is received by the light-receiving element; and
adjusting a focus of the projection unit in accordance with a control signal based on the calculated distance.
